(19) United States
(12) Patent Application Publication
(10) Pub. No.: US 2013/0275262 A1
(43) Pub. Date: Oct. 17, 2013

(54) MULTI-PARTY TRANSACTION SYSTEM WITH COLLECTIVE PURCHASES

(71) Applicant: INDICO INTERACTIVE, INC., San Francisco, CA (US)

(72) Inventors: Michael N. CHAMPLIN, San Francisco, CA (US); David G. CHAMPLIN, San Franciso, CA (US)

(73) Assignee: INDICO INTERACTIVE, INC., San Francisco, CA (US)

(21) Appl. No.: 13/777,913

(22) Filed: Feb. 26, 2013

Related U.S. Application Data
(60) Provisional application No. 61/623,474, filed on Apr. 12, 2012.

(51) Int. Cl. G06Q 20/22

(52) U.S. Cl. CPC G06Q 20/22
USPC 705/26.8; 705/44

(57) ABSTRACT

Embodiments consistent with the present invention enable multiple users, who are members of an associated communication context, to collectively purchase one or more goods or services. One embodiment relates to a method of performing a collective purchase of one or more items, which may be goods and/or services, by a set of multiple users. The one or more items to be purchased are recorded at a collective-purchasing server, and the record(s) of the one or more items may be associated with a reference to the communication context. A user may be authorized to add to, remove from, and modify the one or more items to be purchased by determining if the user is a member of the set of multiple users. Amounts are established that authorized users are to pay as part of the collective purchase. Other embodiments, aspects and features are also disclosed.

### CROSS-REFERENCE TO RELATED APPLICATION(S)

The present application claims the benefit of U.S. Provisional Patent Application No. 61/623,474, filed Apr. 12, 2012, the disclosure of which is hereby incorporated by reference.

### BACKGROUND

1. Technical Field

The present invention relates to electronic commerce and mobile communications.

2. Description of the Background Art

People are increasingly shopping online, including via mobile devices and tablet computers, as well as shopping virtually and later visiting a physical store to pick-up items that were purchased previously online. Hence, on-line retail sales continue to increase.

In another growing trend, mobile communication devices, such as smart phones, are increasingly being used for electronic commerce. For example, people shopping in physical stores are communicating via mobile devices with remote friends to discuss the items they are considering purchasing, to gather second opinions, and to confirm instructions and preferences.

### BRIEF DESCRIPTION OF THE DRAWINGS

FIG. 1 illustrates an arrangement of components for a collective-purchasing system that may be used to provide a purchase experience between two or more users and a business in accordance with an embodiment of the invention.

FIG. 2 shows components of a collective-purchasing server in accordance with an embodiment of the invention.

FIG. 3 is a flow diagram that illustrates the steps of a process for performing shared or collective purchases in accordance with an embodiment of the invention.

FIG. 4 depicts an example computer apparatus for use in implementing system components in accordance with an embodiment of the invention.

### SUMMARY

Embodiments consistent with the present invention enable multiple users, who are members of an associated communication context, to collectively purchase one or more goods or services.

One embodiment relates to a method of performing a collective purchase of one or more items, which may be goods and/or services, by a set of multiple users. The one or more items to be purchased are recorded at a collective-purchasing server, and the record(s) of the one or more items may be associated with a reference to the communication context. The communication context defines the set of multiple users and is utilized so that the set of multiple users may communicate with each other electronically. A user may be authorized to add to, remove from, and modify the one or more items to be purchased by determining if the user is a member of the set of multiple users. Amounts are established that authorized users are to pay as part of the collective purchase.

Another embodiment relates to a collective-purchasing server for performing a remote purchase of an item at a retail location using communication devices. The collective-purchasing server including: at least one processor; a tangible, non-transitory data storage system including memory; a communication system for interconnecting the at least one processor and the data storage system; a network interface for communicating with a network; and computer-readable program code stored in the data storage system for recording one or more items to be purchased, associating with a record or records of the one or more items to be purchased, a reference to the communication context in which the set of multiple users is defined and by way of which the set of multiple users communicate with each other electronically, authorizing a user to add to, remove from, and modify the one or more items to be purchased by determining if the user is a member of the set of multiple users, and establishing amounts that authorized users are to pay as part of a collective purchase of the items to be purchased.

Another embodiment relates to a system for performing a collective purchase of one or more goods or services by a set of multiple users who are members of a communication context. The system includes a collective-purchasing server and a plurality of mobile communication devices executing a client software application for communicating with the collective-purchasing server by way of a data communications network.

Other embodiments, aspects and feature are also disclosed.

### DETAILED DESCRIPTION

Applicants have determined that conventional electronic commerce and mobile communications systems are lacking in support for making a shared or collective purchase, where the purchase is jointly made by more than one identified person. The present application discloses a system and method for performing a multi-party transaction where the purchase of one or more items is jointly made by more than one identified person.

Applicants believe that, as the worlds of communication, mobile commerce, and online shopping intersect, users would benefit from an ability to collaboratively purchase one or more items. In one usage scenario, consider people going shopping who want to buy something together and split the total purchase price. For example, two roommates might be shopping for a coffee maker for their apartment and want to evenly split the cost of this new appliance. In another example, two friends might be shopping for a gift to give to a third friend. Perhaps in this example, the first friend is willing to chip-in some amount and the second friend is willing to pay the remaining balance to reach the full purchase price of the item.

In accordance with an embodiment of the invention, the system disclosed herein enables users to contribute items to a shared collection of items to be purchased, like a shared virtual shopping cart, basket or similar e-commerce container, and make modifications to these items. In addition, the system may enable the users to discuss the items to be purchased in an associated communication context. Then, the users may split the total purchase price of the items, with multiple users contributing payments.

In accordance with an embodiment of the invention, the system associates the shared set of items to be purchased with the shared communication context. Authorization to modify the shared collection of items may be determined by examining the membership of the communication context. In one implementation, any member of the associated communication context is automatically authorized to modify the collection of items to be purchased.

In the context of the present application, a “business activity” may be defined as an experience designed by the business, that leads to an outcome or accomplishment that is valuable for the business.

In the context of the present application, an “interactive interface” may be defined as a collection of software and media resources which, when rendered, shows information to the user and may present the user with one or more user interface controls. When selected, the user interface controls may communicate with local or remote systems and communicate their selection and additional information provided by the user. For example, an interactive interface may enable a user to make a selection from a menu of drinks offered by a coffee restaurant. In an exemplary implementation, the user's selection may be communicated from a mobile communication device executing the interactive interface to a collective-purchasing server over the Internet.

In the context of the present application, a “communication context” may be defined as a group of entities associated with a facility for communication. The associated entities are often people (i.e. accounts of identified end users), but could possibly include computerized or machine agents. Communication may include various forms of exchange of information over a network. Examples include, but are not limited to, SMS and MMS messaging, email, instant messaging, social network posting, social network messaging, document or media collaboration, or voice or video conversation. In this definition, the exchanges of information could be real-time or asynchronous.

The members of the communication context may be established in various ways. Membership may be defined by specifying a group or by adding members individually. In the case of specifying a group, it is possible that a group may be specified that has zero initial members, members being added to the group in the future. As an example of such a group, it is possible that a communication context may be established for the set of users who will occupy a particular conference room at a future time, but that the attendee roster is unknown at the present time. In another case of specifying the members via a group, the group may be an ad hoc group. Examples of ad hoc groups include those that are formed by the members sharing the current location, the members associating their devices together via near field communication, or detecting a shared signal of some form. The set of members of a communication context may vary over time as users are added and removed from the set.

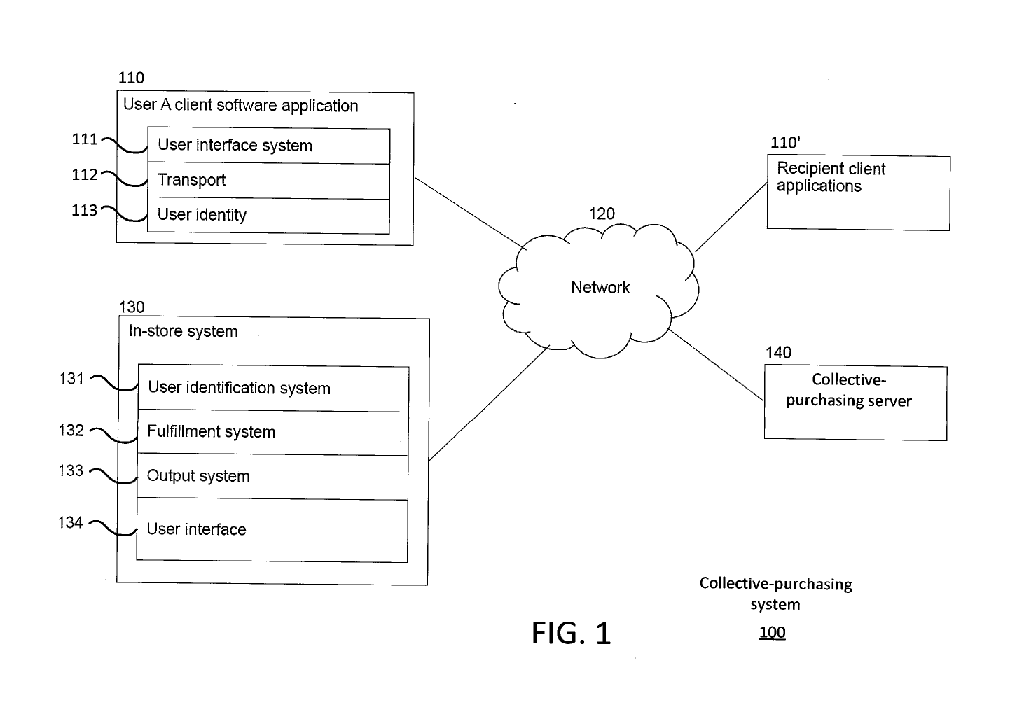

FIG. 1 illustrates an arrangement of components for a collective-purchasing system (100) that may be used to provide a purchase experience between two or more users and a business in accordance with an embodiment of the invention. Each user has a computer, which may be a mobile computing device, such as a smart phone.

The user who begins the business activity may run a client software application (110) on his/her computer device. The client software application may be implemented as web pages and scripts rendered in a browser. The client software application may alternatively be implemented as a native application. The client software application may be used on a variety of computer systems, like a smartphone, a tablet computer, a laptop or other computer, an Internet-connected television, a video game console, etc.

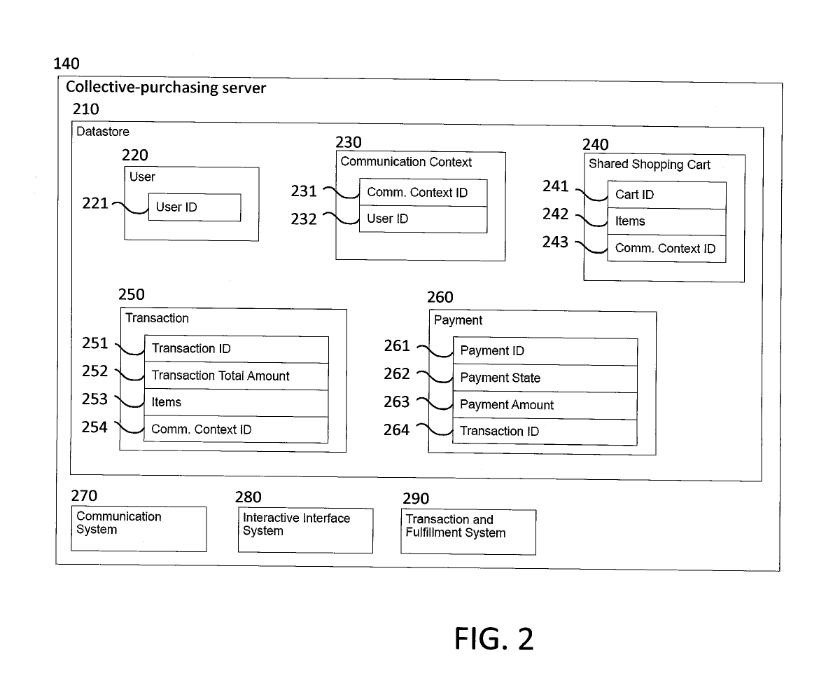

In one implementation, the client software application implements a user interface system (111) that is capable of rendering user interfaces to the user and of accepting and processing user input. The client software application implements a transport (112) that can communicate with the collective-purchasing server (140), which is described in more detail in FIG. 2, over a network (120), such as the Internet, using one or more protocols, such as TCP/IP, HTTP, HTTPS, XMPP, etc. The transport can authenticate the collective-purchasing server using a variety of methods, such as the authentication methods defined in the Transport Layer Security protocol. The client software application also hosts the identity (113) of its user and can provide this to the collective-purchasing server.

Other participants run recipient client software applications (110′) on their computers. Each recipient client software application (110′) may have the same components (111, 112, and 113) as the client software application (110). In one implementation, the client software application (110) and the recipient client software application (110′) may be instances of the same application. Alternatively, they may be different applications, each having the depicted components (111, 112, and 113).

In the embodiment depicted in FIG. 1, the business has an in-store system (130). The in-store system may include an identity system (131) for establishing the identity of an in-store user who is requesting fulfillment for transactions, a retrieval system (132) for obtaining fulfillment instructions from the collective-purchasing server, an output system (133) for manifesting or displaying fulfillment instructions in the store, and a user interface system (134) for enabling an employee of the business to interact during the fulfillment process.

FIG. 2 shows components of a collective-purchasing server (140) in accordance with an embodiment of the invention. In the implementation depicted in FIG. 2, the collective-purchasing server (140) includes a communication system (270) that enables users to exchange messages with each other via interfaces in the client software applications. In other implementations, the communication system associated with the client software applications might exist outside of the collective-purchasing server. The associated communication system might be SMS/MMS, or an instant messaging system, or a social network platform, or email, or a voice or video connection among the users, or combinations of communication systems.

The collective-purchasing server (140) may further include an interactive interface system (280) that generates, stores, delivers, and manages user interfaces that can be utilized by software client applications. In one implementation, the interactive interface system is used to present user interfaces that enable users to engage in the business activity, such as selecting items for purchase.

The collective-purchasing server (140) may further include a transaction and fulfillment system (290) that manages transactions through their lifecycle. Steps of the lifecycle managed by this system may include: collection of items, purchase of items, authorization of payment for purchased items, settlement of payment, and fulfillment of items.

The collective-purchasing server (140) may further include a datastore (210) that stores various records. These records may include user record data (220), communication context data (230), shared shopping cart data (240), transaction record data (250), and payment record data (260). Further description of the stored records will be provided in the detailed description below.

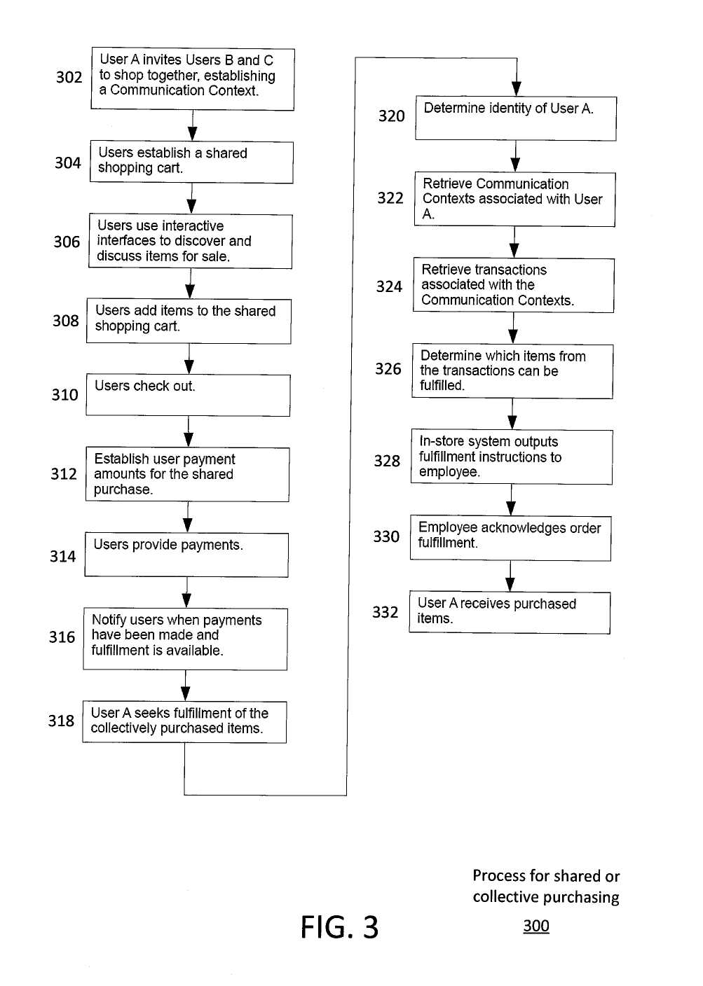

FIG. 3 is a flow diagram that illustrates the steps of an exemplary process (300) for performing shared or collective purchases in accordance with an embodiment of the invention. In this exemplary process, consider that a group of friends, users A, B, and C in this example, intend to split the price of a tent they plan to use on an upcoming camping trip. While there are three users in this example, the number of users may be, in general, two or more.

The users A, B, and C may be shopping using a client software application affiliated, in this example, with an outdoor sporting goods retailer, the application including transport software (112) that enables it to communicate over the Internet with the collective-purchasing server (140), and to display interactive interfaces to the user and respond to user actions using a user interface system (111).

User A may communicate with one or more other participants, users B and C in this example, using the client software application (110) and the collective-purchasing server (140). Users B and C need not be in the same location as user A. Users B and C may use recipient client software applications (110′). In one implementation, the client software application (110) presents a user interface control to user A that helps the user begin a business activity, such as inviting remote friends or coworkers to shop together.

Per step (302), the participants may begin the activity and establish a shared Communication Context. The collective-purchasing server (140) may represent each participant by a user identifier (ID) (221) associated with a user record in the user record data (220) in the datastore (210). The collective-purchasing server (140) may also associate each participant's user ID (232) with a shared communication context ID (231) in one or more communication context records in the communication context data (230).

The establishment of the communication context may include creating a new communication context or utilizing a pre-existing communication context. For example, User A may select a communication context that includes a long-running communication thread among Users A, B, and C. Note that a communication context may be established not by an initial user reaching out to other users, but through alternate means. In one alternate example, an agent of the business may simultaneously send notifications to Users A, B, and C, pulling each user into a shared communication context.

Per step (304), users may choose to share a virtual shopping cart in which they collect items they will purchase collectively. As shown in FIG. 2, the collective-purchasing server (140) may keep a record in its datastore (210) that associates a shared shopping cart ID (241) and its contents or items (242) with the users' shared communication context ID (243).

Per step (306), Users A, B, and C may use interactive interfaces to discover and discuss items to add to their shared shopping cart. When a user attempts to add an item to the shared shopping cart per step (308), the collective-purchasing server may authorize the user's action by first retrieving from the datastore (210) the communication context ID (243) associated with the shared shopping cart ID (241), and then ensuring that the user is a member of the shared Communication Context (230) by comparing the user ID of the user attempting to add the item against the user IDs (232) that are associated with the communication context ID (231). The collective-purchasing server (140) may use the same authorization mechanism to authorize attempts to view, modify, or delete the contents of the shared shopping cart.

When the users have decided on the tent they wish to purchase and choose to check out per step (310), the collective-purchasing server (140) collects the goods and/or services (242) specified in the shared shopping cart (240) and forms a transaction record with a transaction ID (251) in the transaction record data (250). The transaction record associates the transaction total amount (252) and the items the users intend to purchase (253) with the users' shared communication context ID (254).

The collective-purchasing system (100) may next establish the amount each user will pay for the goods or service items (253) in the transaction per step (312). In one implementation, the collective-purchasing server (140) divides the total amount (252) required to purchase the items (253) by the number of participants in the communication context. In another implementation, the client software applications (110 and 110′) present the users with user interfaces that enable users to specify the amount each will pay. Payment information may be captured in a payment record having a payment ID (261), payment state (262), payment amount (263), and the associated transaction ID (264) in the payment record data (260) in the datastore (210).

Per step (314), each user begins a payment flow and pays his or her specified amount (263) indicated in the payment record. As payments are completed, the collective-purchasing server (140) updates the payment state (262) of the associated payment records in the payment record data (260) in the datastore (210). The payment state (262) may be updated from an unpaid state to a paid state upon completion of a payment.

In one implementation, per step (316), the collective-purchasing server (140) notifies one or more users (possibly all users) in the shared communication context when payments have been made and the items are to be fulfilled.

Per step (318), User A may next seek fulfillment of the goods and services that he and his co-purchasing friends have purchased. In one implementation, User A may visit the physical store location of the outdoor goods retailer to pick up the purchased tent or other item.

Per step (320), in order to provide User A with the purchased goods and services, the business establishes User A's identity. The business may have in its location an in-store system (130) that is capable of identifying a user via an identification system (131) and communicating with the server system to produce the corresponding user record (220). User identification may be implemented in a variety of ways. For example, an optical scanning device might be connected to the in-store system, which is capable of reading a bar code displayed on a smartphone screen. As another example, a near field communication sensor could be connected to the in-store system that is capable of retrieving a unique identifier from the user's device. Additionally, the in-store system may determine the user's identity by examining the user's credit card or driver's license, or by finding the user record that matches the user's name and phone number, or by matching a shared secret presented by the user to the user record to which the shared secret has been assigned.

Once User A's identity has been determined, the in-store system next requests fulfillment instructions for User A via its fulfillment system (132). In one implementation, the collective-purchasing server (140) uses User A's user ID to retrieve per step (322) the communication context records associated with the user ID (232) for User A. Given this set of communication context records, the collective-purchasing server (140) next retrieves, per step (324) transaction records whose communication context IDs (254) match communication context IDs (231) in the set.

In an alternative implementation for generating the set of transaction records, the in-store system may be implemented to accept as input a unique token that identifies one of the transactions in the communication context. The collective-purchasing server (140) may use the transaction record ID (251) to retrieve the associated transaction record, including the transaction's communication context ID (254). The collective-purchasing server (140) may then retrieve all transactions that match this communication context ID (254).

In another alternative implementation for generating the set of transaction records, the collective-purchasing server (140) may generate a unique token and associate the token with the set of transactions. The collective-purchasing server (140) may issue the token to User A. The token may be represented in many ways, including providing User A with a QR code or a passphrase. User A would then present the token to the in-store system (130), which would then provide the token to the collective-purchasing server (140). The collective-purchasing server (140) may retrieve the set of transactions associated with the token.

Once the set of transactions for which User A is eligible to receive fulfillment has been determined, the collective-purchasing server (140) may next proceed with the fulfillment process. In one implementation, the collective-purchasing server (140) provides the set of transactions to the fulfillment system, which may have components both within the server system (transaction and fulfillment system 290) as well as within the in-store system (fulfillment system 132). The fulfillment system determines which of the goods and services specified by the transactions are ready to be delivered to User A per step (326). Fulfillment criteria could include requiring successful total payment for the purchased items, ensuring items are available in the store's inventory, etc. In one implementation, successful total payment could mean that all of the multiple payments associated with this shared transaction have succeeded. In another implementation, successful total payment could mean that the total amount of all of the successful payments is at least as great as the total transaction amount.

The in-store system (130) may next use its output system (133) to output the orders so that they may be viewed by an employee in the store per step (328). For example, the in-store system (130) may be connected to a printer and may print a description of the purchased items, or it may show the purchased items in a graphical user interface. If appropriate, the in-store system (130) may provide a user interface (134) that enables an employee to indicate whether or not ordered items have been delivered to User A, or to modify some or all of the orders per step (330). The in-store system (130) may then update the server system to indicate which orders have been fulfilled. Alternatively, the in-store system (130) may update the server system automatically to indicate which orders have been fulfilled. The employee can then deliver the ordered items to User A per step (332).

Alternatively, the in-store system (130) may produce the ordered goods directly and provide them directly to User A, without involving an employee. For example, Users A, B, and C might have participated in a shared business activity involving the collaborative purchase of an electronic ticket. In one example, perhaps Users A, B, and C will split the price of a one-day parking pass. As described above, Users A, B, and C may have collaboratively purchased the parking pass. User A may now present his smartphone device, and perhaps a screen or other output from the client software application (110), to an in-store system (130) at the parking garage. The in-store system (130), which in one implementation may resemble and automated ticket vending machine, identifies User A, and retrieves information about transactions associated with User A from the collective-purchasing server (140), as in steps (322-326). The order retrieval system may then print the parking pass and provide the pass to User A.

Alternatively, instead of picking up the purchased goods from a physical location, the business may support shipping purchases to customers. One of the members of the shared communication context may arrange for the purchased goods to be shipped to a location the user specifies. In this implementation, the business could complete fulfillment once the total amount of the purchased items has been successfully paid.

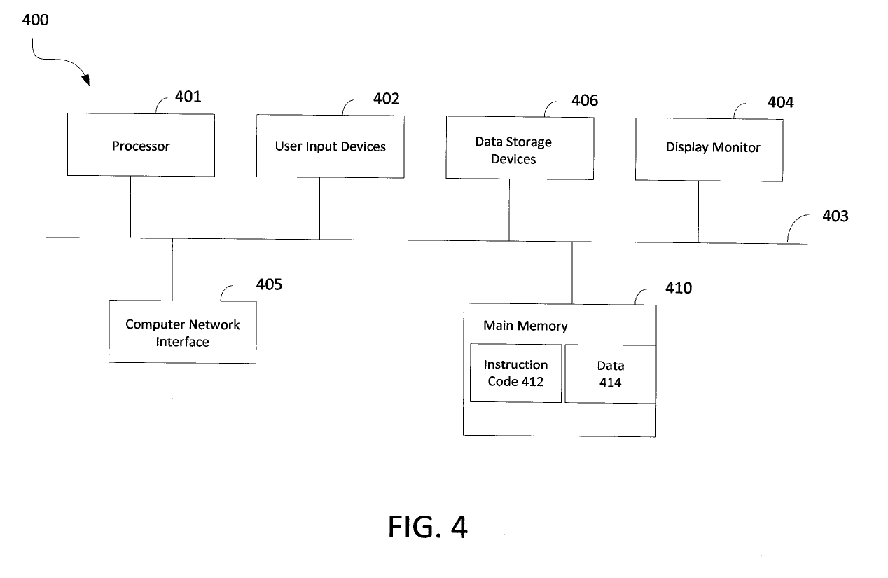

FIG. 4 depicts a simplified form of an example computer apparatus (400) for use in implementing system components in accordance with an embodiment of the invention. Such a computer apparatus may be used, for example, to implement computing devices of the users for executing the client software applications (110 and 110′), the in-store system (130), and the collective-purchasing server (140).

FIG. 4 depicts a simplified example of a computer apparatus (400) in accordance with an embodiment of the invention. This figure shows just one simplified example of such a computer apparatus. A computer apparatus (400) having the illustrated components may be utilized, for example, as client computing devices for executing client computer software applications (110 and/or 110′), as a server computer for use as a collective-purchasing server (140), and to perform functions of an in-store system (130).

As shown, the computer apparatus (400) may include one or more processors (401), such as those from the Intel Corporation of Santa Clara, Calif., for example. The computer apparatus 400 may have one or more buses (403) communicatively interconnecting its various components. The computer apparatus (400) may include one or more user input devices 402 (e.g., keyboard, mouse, etc.), a display monitor (404) (e.g., liquid crystal display, flat panel monitor, etc.), a computer network interface (405) (e.g., network adapter, modem), and a data storage system that may include one or more data storage devices (406) which may store data on a hard drive, semiconductor-based memory, optical disk, or other tangible non-transitory computer-readable storage media, and a main memory (410) which may be implemented using random access memory, for example.

In the example shown in this figure, the main memory (410) includes instruction code (412) and data (414). The instruction code (412) may comprise executable computer-readable program code (i.e., software) components which may be loaded from the tangible non-transitory computer-readable medium of the data storage device (406) to the main memory (410) for execution by the processor(s) (401). In particular, the instruction code (412) may be programmed to cause the computer apparatus (400) to perform the steps described herein.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of performing a collective purchase of one or more goods or services by a set of multiple users who are members of a communication context, the method comprising:
recording at a collective-purchasing server one or more items to be purchased;
associating with a record or records of the one or more items to be purchased, a reference to the communication context in which the set of multiple users is defined and by way of which the set of multiple users communicate with each other electronically;
authorizing a user to add to, remove from, and modify the one or more items to be purchased by determining if the user is a member of the set of multiple users; and
establishing amounts that authorized users are to pay as part of a collective purchase of the items to be purchased.

2. The method of claim 1, further comprising:
authenticating a user who is requesting fulfillment of one or more items to be fulfilled; and
identifying one or more transactions that have, associated with a record of the transaction, a communication context which has the user who is requesting fulfillment as a member.

3. The method of claim 2, further comprising:
authorizing fulfillment of the one or more items to be fulfilled to the user who is requesting fulfillment if the one or more items to be fulfilled are associated with the one or more transactions and if a total sum of payments is at least as great as a total purchase price for each of the one or more transactions.

4. The method of claim 1, wherein an amount that each authorized user is to pay is established by dividing a total purchase amount of the one or more items to be purchased by a number of members in the set of multiple users.

5. The method of claim 1, wherein an amount that an authorized user is to pay is established by the authorized user.

6. The method of claim 1, wherein an amount that an authorized user is to pay is established by another party or system and agreed to by the authorized user.

7. The method of claim 1, further comprising:
sending a notification message to one or more users of the set of multiple users, wherein determination of when to send the notification message is based on a total amount of payment collected from the set of multiple users.

8. The method of claim 1, wherein the one or more items to be purchased by the set of multiple users is represented as a virtual shopping container for collecting items to be purchased.

9. The method of claim 1, wherein one or more users of the set of multiple users utilize a mobile computing device to participate in the collective purchase experience, wherein the mobile computing device is a device of a group of devices consisting of smart phones and tablet computers.

10. The method of claim 2, wherein the one or more items to be fulfilled are fulfilled in a physical store location.

11. The method of claim 10, wherein at least one user of the set of multiple users engages in the collective purchase experience while that user is physically located within the physical store location from which the one or more items to be purchased are being purchased.

12. The method of claim 2, wherein fulfillment of the one or more items to be fulfilled occurs by delivering the collectively purchased items to an address specified by one of the authorized users.

13. The method of claim 2, wherein fulfillment of the one or more items to be fulfilled involves the execution of a service.

14. A collective-purchasing server for performing a remote purchase of an item at a retail location using communication devices, the collective-purchasing server comprising:
at least one processor;
a tangible, non-transitory data storage system including memory;
a communication system for interconnecting the at least one processor and the data storage system;
a network interface for communicating with a network;
computer-readable program code stored in the data storage system for
recording one or more items to be purchased,
associating with a record or records of the one or more items to be purchased, a reference to the communication context in which the set of multiple users is defined and by way of which the set of multiple users communicate with each other electronically,
authorizing a user to add to, remove from, and modify the one or more items to be purchased by determining if the user is a member of the set of multiple users, and
establishing amounts that authorized users are to pay as part of a collective purchase of the items to be purchased.

15. The collective-purchasing server of claim 14 further comprising:
computer-readable program code stored in the data storage system for
authenticating a user who is requesting fulfillment of one or more items to be fulfilled, and
identifying one or more transactions that have, associated with a record of the transaction, a communication context which has the user who is requesting fulfillment as a member.

16. The collective-purchasing server of claim 15 further comprising:
computer-readable program code stored in the data storage system for authorizing fulfillment of the one or more items to be fulfilled to the user who is requesting fulfillment if the one or more items to be fulfilled are associated with the one or more transactions and if a total sum of payments is at least as great as a total purchase price for each of the one or more transactions.

17. A system for performing a collective purchase of one or more goods or services by a set of multiple users who are members of a communication context, the system comprising:
a collective-purchasing server comprising
at least one processor,
a tangible, non-transitory data storage system including memory,
a communication system for interconnecting the at least one processor and the data storage system,
a network interface for communicating with a data communication network,
computer-readable program code stored in the data storage system for
recording one or more items to be purchased,
associating with a record or records of the one or more items to be purchased, a reference to the communication context in which the set of multiple users is defined and by way of which the set of multiple users communicate with each other electronically,
authorizing a user to add to, remove from, and modify the one or more items to be purchased by determining if the user is a member of the set of multiple users, and
establishing amounts that authorized users are to pay as part of a collective purchase of the items to be purchased; and
a plurality of mobile communication devices executing a client software application for communicating with the collective-purchasing server by way of the data communications network.

19. The system of claim 18, wherein the collective-purchasing server further comprises:
computer-readable program code stored in the data storage system for
authenticating a user who is requesting fulfillment of one or more items to be fulfilled, and
identifying one or more transactions that have, associated with a record of the transaction, a communication context which has the user who is requesting fulfillment as a member.

20. The system of claim 19, wherein the collective-purchasing server further comprises:
computer-readable program code stored in the data storage system for authorizing fulfillment of the one or more items to be fulfilled to the user who is requesting fulfillment if the one or more items to be fulfilled are associated with the one or more transactions and if a total sum of payments is at least as great as a total purchase price for each of the one or more transactions.
